(19) United States
(12) Patent Application Publication
(10) Pub. No.: US 2020/0314344 A1
(43) Pub. Date: Oct. 1, 2020

(54) IMAGE PROCESSING METHOD FOR PHOTOGRAPHY DEVICE, PHOTOGRAPHY DEVICE AND MOVABLE PLATFORM

(71) Applicant: SZ DJI Technology Co., Ltd, Shenzhen (CN)

(72) Inventor: Xubin Sun, Shenzhen (CN)

(21) Appl. No.: 16/900,416

(22) Filed: Jun. 12, 2020

Related U.S. Application Data
(63) Continuation of application No. PCT/CN2017/120242, filed on Dec. 29, 2017.

(51) Int. Cl. H04N 5/232

(52) U.S. Cl. CPC H04N 5/23267; H04N 5/23254

(57) ABSTRACT

An image processing method for photography device includes determining a vibration direction of the photography device when acquiring a current image relative to when acquiring a reference image, extracting an image portion corresponding to the vibration direction from the current image according to the vibration direction, and determining the image portion as a target captured image.

### CROSS-REFERENCE TO RELATED APPLICATION

This application is a continuation of International Application No. PCT/CN2017/120242, filed Dec. 29, 2017, the entire content of which is incorporated herein by reference.

### TECHNICAL FIELD

The present disclosure relates to an image processing field, and more particularly, to an image processing method for photography device, photography device and movable platform.

### BACKGROUND

When a camera is capturing images, a vibration from a hand of an operator holding the camera or carrier (e.g., a movable platform) that carries the camera may lead to a blurry photo or video.

In existing technologies, a method for anti-vibration through software is provided. Specifically, a sensor (e.g., a gyroscope) is used to detect the vibration direction of the camera, and a specific algorithm is used to capture the part including same images as an effective image, and images on the edge are removed, to achieve the purpose of anti-vibration.

In existing technologies, a part of an image at an edge is eliminated, leading to a reduction of the effective pixels of the image captured by the camera and hence a poor image captured by the camera.

### SUMMARY

In accordance with the disclosure, there is provided an image processing method for photography device including determining a vibration direction of the photography device when acquiring a current image relative to when acquiring a reference image, extracting an image portion corresponding to the vibration direction from the current image according to the vibration direction, and determining the image portion as a target captured image.

Also in accordance with the disclosure, there is provided a photography device including an image sensor and a processor configured to determine a vibration direction of the photography device when acquiring a current image relative to when acquiring a reference image, extract an image portion corresponding to the vibration direction from the current image according to the vibration direction, and determine the image portion as a target captured image.

Also in accordance with the disclosure, there is provided a movable platform including the above photography device.

### BRIEF DESCRIPTION OF THE DRAWINGS

FIG. 1 is a schematic flowchart showing an image processing method for a photography device according to an example embodiment.

FIG. 2 is a schematic diagram showing an actual image range of a captured image with a barrel distortion.

FIG. 3 is a schematic diagram showing the actual captured image with the barrel distortion and a range and a location of an image sensor.

FIG. 4 is a schematic diagram showing an actual image range of a captured image with a pincushion distortion.

FIG. 5 is a schematic diagram showing the actual captured image with the pincushion distortion and a range and a location of an image sensor.

FIG. 6 is a schematic flowchart showing an image processing method for a photography device according to an example embodiment.

FIG. 7 is a schematic flowchart showing an image processing method for a photography device according to an example embodiment.

FIG. 8 is a schematic flowchart showing an image processing method for a photography device according to an example embodiment.

FIG. 9 is a schematic flowchart showing an image processing method for a photography device according to an example embodiment.

FIG. 10 is a schematic flowchart showing an image processing method for a photography device according to an example embodiment.

FIG. 11 is a schematic structural diagram of a photography device according to an example embodiment.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

The term “and/or” used herein is merely an association relationship describing associated objects, indicating that there can be three relationships. For example, A and/or B can indicate, A alone, A and B, and B alone. The character “/” generally indicates that the related objects before and after are an “or” relationship. In the case of no conflict, the characteristics in the embodiments of the present disclosure can be arbitrarily combined.

The present disclosure provides an image processing method for a photography device, which does not reduce the original effective image during anti-vibration processing, thereby ensuring the presentation effect of the image captured by the camera.

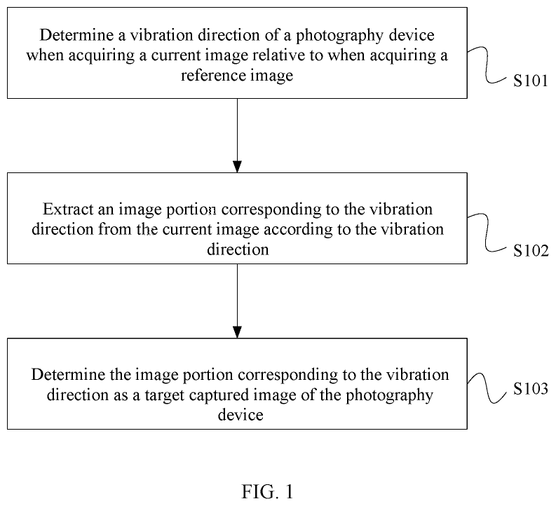

FIG. 1 is a schematic flowchart showing an image processing method for a photography device according to an example embodiment. As shown in FIG. 1, the method include processes described below.

At S101, a vibration direction of a photography device when acquiring a current image relative to when acquiring a reference image is determined. That is, the vibration direction of the photography device can be determined by, e.g., a relative displacement of the photography device between a time of acquiring the current image and a time of acquiring the reference image, i.e., a position of the photography device at the time of acquiring the current image relative to a position of the photography device at the time of acquiring the reference image.

In some embodiments, the photography device can be a device that can capture an image, e.g., a camera, a video camera, etc.

Specifically, this embodiment can be applied to a video capturing process, where a plurality of frames of image are captured. The current image is a frame of image captured by the photography device at the current time, and the reference image is a frame of image captured before the current image. For example, the reference image can be the frame of image immediately preceding the current image, or the reference image can be a frame of image that is a preset number of frames before the current image, or the reference image can be a frame of image set by a user.

In some embodiments, the method can be applied to a process of capturing an image by a camera. For example, a current reference image can be a preset image at a preset position.

In some embodiments, when a photography device captures the current image, a sensor of the photography device can be used to determine the vibration direction of the current image relative to the reference image.

At S102, an image portion corresponding to the vibration direction in the current image is extracted according to the vibration direction. The extracted images corresponding to different vibration directions are different according to the different vibration direction, which is described in detail in the following embodiments.

At S103, the image portion corresponding to the vibration direction is determined as a target captured image of the photography device.

After the image portion corresponding to the vibration direction is extracted, the extracted image portion is determined as the target captured image, that is, a frame of image of the current time in the captured video.

In this embodiment, the photography device determines the vibration direction when acquiring the current image relative to when acquiring the reference image, and extract the image portion corresponding to the vibration direction. The extracted image portion does not reduce the original effective image, and hence the presentation effect of the image captured by the camera can be ensured.

In some embodiments, before S102, the photography device can further execute distortion correction on the current image, to obtain a corrected captured image.

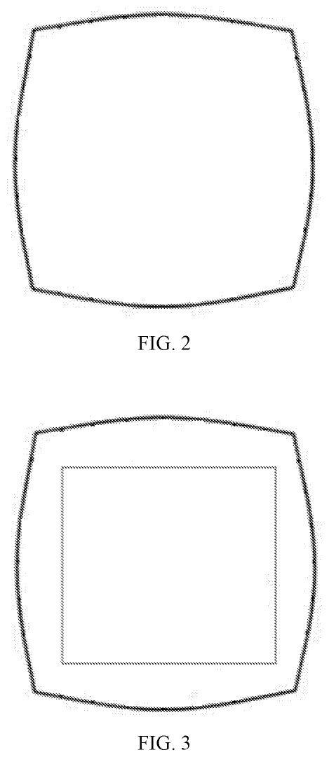

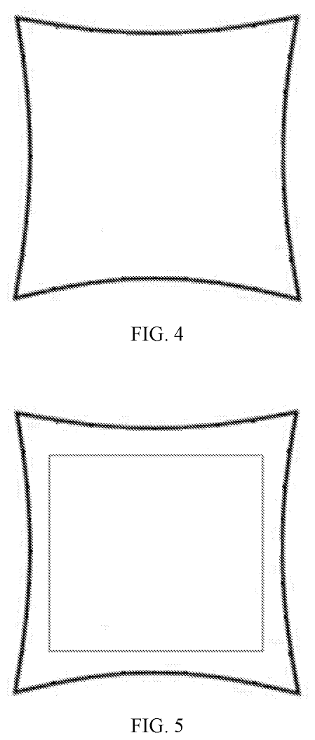

Specifically, a camera or a video camera may have lens distortion when photographing, and lens distortion includes a barrel distortion, a pincushion distortion, or a mixed distortion (a mixture of the barrel distortion and the pincushion distortion). FIG. 2 is a schematic diagram showing the actual image range of a captured image with a barrel distortion. FIG. 3 is a schematic diagram showing the correction of the barrel distortion and the range and location of an image sensor. As shown in FIG. 2 and FIG. 3, a barrel distortion exists in a square range of the image sensor. The barrel distortion correction is to restore the image in the square image sensor range to the image range shown in FIG. 2. FIG. 4 is a schematic diagram showing the actual image range of a captured image with a pincushion distortion. FIG. 5 is a schematic diagram showing the correction of the pincushion distortion and the range and location of an image sensor. As shown in FIG. 4 and FIG. 5, a pincushion distortion exists in a square range of the image sensor. The pincushion distortion correction is to restore the image in the square image sensor range to the image range shown in FIG. 4. A mixed distortion is a compression of an image range resulting from combining FIG. 2 and FIG. 4 into the square image sensor range, in which the image of the object on the image sensor is distorted. The image needs to be restored to a same shape as the actual object, i.e., a distortion correction is needed.

In some embodiments, an image larger than the image sensor range can be obtained after a distortion correction for all types of distortion.

In some embodiments, a process of a distortion correction for a barrel distortion can include correcting the distortion of the captured image, where the image is stretched to the shape shown in FIG. 2 so that the shape of an object in the stretched image is consistent with the shape of the actual object. An image portion with a size of the image sensor can be extracted from the stretched image as a corrected captured image.

Correspondingly, the above process S102 may specifically include extracting an image portion corresponding to the vibration direction from the corrected captured image. When the corrected captured image is obtained, the image portion corresponding to the vibration direction is extracted from the corrected captured image according to the vibration direction, and the extracted image portion can be used as a target captured image of the photography device.

In some embodiments, the size of the image portion corresponding to the vibration direction extracted by the photography device is consistent with the pixel size of the image sensor of the photography device, i.e., the size of the image portion extracted from the corrected image is the maximum image size supported by the image sensor of the photography device. In some other embodiments, it is also possible to extract an image portion from the corrected image that is larger or smaller than the maximum image size supported by the image sensor of the photography device.

In this embodiment, the photography device extracts an image portion corresponding to a vibration direction from the distortion-corrected image, i.e., performing an anti-vibration treatment during the distortion correction process. A lens distortion itself produces a redundant area of the image that needs to be discarded. Consistent with the disclosure, only the position of the redundant portion that needs to be discarded is adjusted according to the vibration direction, and the size of the obtained extracted image portion remains consistent with the size of the image sensor. Therefore, the method consistent with the disclosure does not reduce the original effective image, thereby ensuring the presentation effect of the image captured by the camera. Further, during the distortion correction process, the anti-vibration treatment is performed at the same time. The simultaneous implementation of these two processes saves the processing time and speeds up the processing.

In one embodiment, when the photography device extracts an image portion corresponding to a vibration direction from the corrected captured image, it may also extract the image portion taking into consideration a vibration amplitude in the vibration direction. The vibration amplitudes in different vibration directions have different meanings. For example, if the vibration direction is a yaw direction, the vibration amplitude is a vibration angle in this direction. If the vibration direction is a horizontal direction, the vibration amplitude is a vibration distance in this direction.

Specifically, before the photography device extracts the image portion corresponding to the vibration direction in the corrected captured image, the photography device can determine the vibration amplitude in the vibration direction. Further, when the photography device extracts the image portion corresponding to the vibration direction, it can extract the image portion corresponding to the vibration direction in the corrected captured image according to the vibration direction and the vibration amplitude.

Based on above embodiment, there is provided a specific process in which a photography device extracts an image portion corresponding to a vibration direction in a corrected captured image according to the vibration direction and a vibration amplitude.

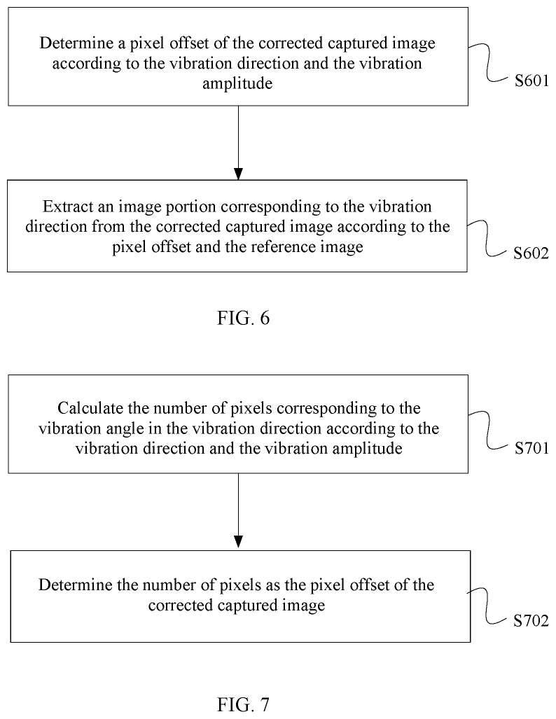

FIG. 6 is a schematic flowchart showing an image processing method for a photography device according to an example embodiment. As shown in FIG. 6, the method for the photography device to extract an image portion corresponding to a vibration direction in a corrected captured image according to the vibration direction and the vibration amplitude includes the following.

At S601, a pixel offset of the corrected captured image is determined according to the vibration direction and the vibration amplitude.

In some embodiments, the above pixel offset can refer to the pixel offset of the corrected current image relative to the corrected reference image.

In some embodiments, the reference image can be the frame of image immediately preceding the current image, or the reference image can be a frame of image that is a preset number of frames before the current image, or the reference image can be a frame of image set by a user.

At S602, an image portion corresponding to the vibration direction is extracted from the corrected captured image according to the pixel offset and the reference image.

Specifically, the method used by the photography device when extracting an image portion corresponding to the vibration direction is different for different vibration directions. The specific methods of the photography device determining the pixel offset of the corrected captured image for different vibration directions are described below.

The present disclosure provides a method for a yaw and/or a pitch direction. When the vibration direction is the yaw and/or pitch direction, the vibration amplitude in the vibration direction is a changing angle of the yaw angle and/or a changing angle of the pitch angle.

The vibration in the yaw and pitch directions may include a vibration only in the yaw direction, a vibration only in the pitch direction, or a vibration in both the yaw and the pitch directions. The vibration in both the yaw and the pitch directions is a superposition of the vibration in the yaw direction and the vibration in the pitch direction. The pixel offset in the superposition direction can be obtained through a superposition of the pixel offset in the yaw direction and the pixel offset in the pitch direction.

The method of determining the pixel offset in the yaw direction and the pitch direction is the same. In this embodiment, the yaw direction is used as an example for illustrative purposes.

FIG. 7 is a schematic flowchart showing an image processing method for a photography device in this embodiment. As shown in FIG. 7, the method of the photography device determining the pixel offset of the corrected captured image in the yaw direction or the pitch direction includes processes described below.

At S701, the number of pixels corresponding to the vibration angle in the vibration direction is calculated according to the vibration direction, the vibration amplitude, and the Field of Vision (FOV) of the photography device.

At S702, the number of pixels is determined as the pixel offset of the corrected captured image.

If the vibration direction is a yaw direction, the vibration amplitude is the changing angle of the yaw angle, through which the corresponding number of pixels can be calculated. Specifically, the number of pixels corresponding to the vibration angle in the vibration direction can be calculated by the following Equation (1).

Number of pixels=Number of pixels in a column/row of the sensor in the vibration direction*(Vibration angle/FOV) (1)

For example, if the photography device is offset by 1 degree in the yaw direction, the FOV of the photography device is 90 degree, and the number of pixels in a column/row of the sensor in the yaw direction is 1890, the number of pixels can be calculated using above Equation (1) as 1890*(1/90)=21. That is, if the photography device is offset by 1 degree in the yaw direction, the number of pixels corresponding to the offset is 21.

In this embodiment, the number of pixels corresponding to the vibration angle in the vibration direction can be calculated according to the vibration amplitude in the yaw direction and/or the pitch direction, and the pixel offset in the vibration direction can be determined, and hence an image portion can be accurately extracted from the corrected captured image based on the pixel offset.

The present disclosure also provides a method for a roll direction. When the vibration direction is the roll direction, the vibration amplitude in the vibration direction is a changing angle of the roll angle.

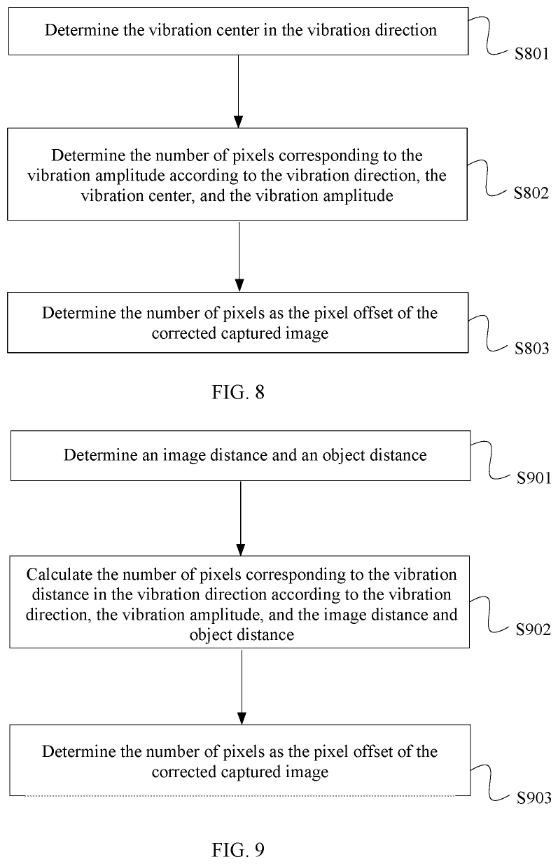

FIG. 8 is a schematic flowchart showing an image processing method for a photography device in this embodiment. As shown in FIG. 8, the method of the photography device determining the pixel offset of the corrected captured image in the roll direction includes processes described below.

At S801, the vibration center in the vibration direction is determined. In some embodiments, the position of the vibration center in the vibration direction is not fixed. For example, the vibration center may be directly obtained according to an image sensor, or the vibration center may be obtained by comparing a current image with an image immediately preceding the current image by a photography device.

At S802, the number of pixels corresponding to the vibration amplitude is determined according to the vibration direction, the vibration center, and the vibration amplitude.

In some embodiments, the vibration in the roll direction can be a clockwise vibration or a counterclockwise vibration. For example, when the photography device vibrates in the clockwise direction, the number of offset pixels can be determined according to the changing angle in the clockwise direction and the vibration center determined above. Specifically, a reference pixel point can be determined according to the clockwise changing angle and the vibration center, and then the number of pixels moved by the reference pixel point maybe determined according to the distance of the reference pixel point from the vibration center.

At S803, the number of pixels is determined as the pixel offset of the corrected captured image.

In this embodiment, the number of pixels corresponding to the vibration angle in the vibration direction can be calculated according to the vibration center and the vibration amplitude in the roll direction, and the pixel offset in the vibration direction can be determined, and hence an image portion can be accurately extracted from the corrected captured image based on the pixel offset.

In the specific implementation process, the vibration of the photography device may occur only in one vibration direction, or may occur in two or more directions simultaneously. For example, the vibration device may vibrate in the pitch direction, the yaw direction, and the roll direction at the same time, i.e., the superposition of the vibrations in various vibration directions. The photography device may separately determine the pixel offsets in each vibration direction, and then superimpose the pixel offsets in each vibration direction to obtain the final pixel offset.

The present disclosure also provides a method for a horizontal vibration or a vertical vibration. When the vibration direction is the horizontal or vertical direction, the vibration amplitude in the vibration direction is a vibration distance in the horizontal vibration direction or a vibration distance in the vertical vibration direction.

The method of determining the pixel offset in the horizontal direction and the vertical direction is the same. In this embodiment, the horizontal direction is used as an example for illustrative purposes.

FIG. 9 is a schematic flowchart showing an image processing method for a photography device in this embodiment. As shown in FIG. 9, the method of the photography device determining the pixel offset of the corrected captured image in the horizontal direction includes processes described below.

At S901, an image distance and an object distance are determined, where the image distance can be a distance from the lens plane to the image plane, and the object distance can be a distance from the lens plane to the object plane.

At S902, the number of pixels corresponding to the vibration distance in the vibration direction is calculated according to the vibration direction, the vibration amplitude, and the image distance and the object distance.

In some embodiments, the number of pixels corresponding to the vibration distance in the vibration direction can be calculated by the following Equation (2).

Number of pixels=(Image distance*Vibration amplitude)/(Object distance*Pixel pitch) (2)

For example, if the vibration amplitude of the photography device in the horizontal direction (i.e., vibration distance) is 1, the image distance is 2, the object distance is 1000, and the pixel pitch is 0.0005, the number of pixels can be calculated using above Equation (2), (2*1)/(1000*0.0005)=10. That is, if the photography device is offset by 1 in the horizontal direction, the number of pixels corresponding to the offset is 10.

At S903, the number of pixels is determined as the pixel offset of the corrected captured image.

In this embodiment, the number of pixels corresponding to the vibration distance in the horizontal direction or the vertical direction can be calculated according to the vibration amplitude in the horizontal direction or the vertical direction, the image distance and the object distance. The pixel offset in the vibration direction can be determined, and hence an image portion can be accurately extracted from the corrected captured image based on the pixel offset.

Based on above embodiment, there is provided a specific method in which an image portion in a corrected captured image is extracted according to a pixel offset and a reference image.

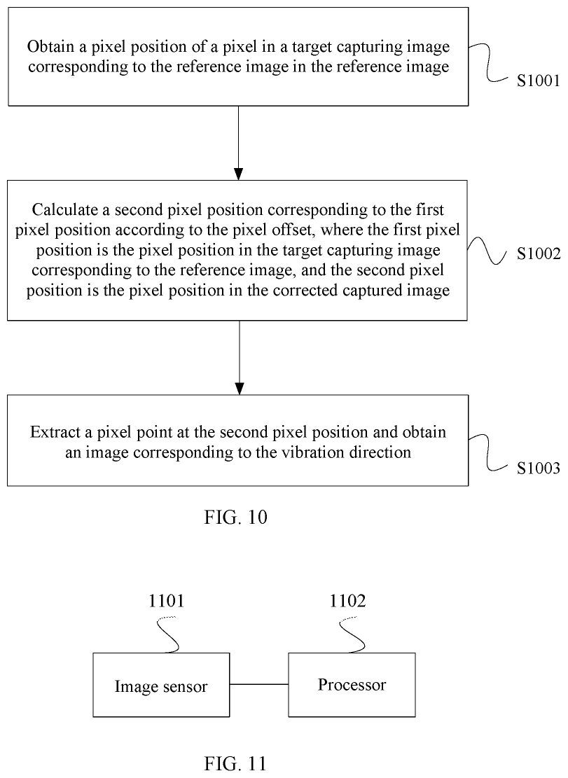

FIG. 10 is a schematic flowchart showing an image processing method for a photography device according to an example embodiment. As shown in FIG. 10, the process S602 that an image portion corresponding to a vibration direction in a corrected captured image is extracted according to a pixel offset and a reference image is specifically described below.

At S1001, a pixel position of a pixel in a target captured image corresponding to the reference image in the reference image is obtained, where the target captured image corresponding to the reference image is an image generated after the reference image is subject to a distortion correction and an extraction, and is also referred to as a “reference target captured image.” The pixel in the reference target captured image is also referred to as a “reference target pixel.”

Specifically, the pixels in the target captured image corresponding to the reference image are extracted from the reference image, and each pixel in the target captured image corresponding to the reference image has a specific position in the reference image, i.e., the pixel position. The photography device can directly record the position of each pixel in the target captured image generated after the extraction, when the reference image is subject to the distortion correction and the extraction. Further, in this process, the recorded pixel position can be read directly.

At S1002, a second pixel position corresponding to the first pixel position is calculated according to the pixel offset, where the first pixel position is the pixel position in the target captured image corresponding to the reference image, i.e., the pixel position determined at S1001, and the second pixel position is the pixel position in the corrected captured image.

When a vibration occurs, the current image captured by the photography device has a pixel position shift compared to the reference image, and the shift amount is the pixel shift amount determined by the embodiment. In this process, after the first pixel position of each pixel point in the target captured image corresponding to the reference image is obtained, the photography device can calculate the second pixel position corresponding to the first pixel position according to the pixel offset.

Specifically, the second pixel position corresponding to the first pixel position can be obtained by traversing all the first pixel positions in the target captured image corresponding to the reference image and adding the pixel offset to the position values. The position of each pixel in the target captured image corresponding to the current image in the current image can be determined.

At S1003, a pixel point at the second pixel position is extracted and an image portion corresponding to the vibration direction is obtained. Specifically, after all the second pixel positions are determined, the pixels at the second pixel position are directly extracted from the corrected captured image, and an image portion corresponding to the vibration direction can be obtained.

In the specific implementation process, the vibration of the photography device may occur only in one vibration direction, or may occur in two or more directions simultaneously. For example, the vibration device may vibrate in the pitch direction, the yaw direction, and the roll direction at the same time, i.e., the superposition of the vibrations in various vibration directions. The photography device may separately determine the pixel offsets in different vibration directions, and then superimpose the pixel offsets in all vibration directions to obtain the final pixel offset. Further, in this embodiment, image capture can be performed based on the final pixel offset obtained by the superposition.

In this embodiment, after the pixel offset is obtained, the pixel position of the pixel point to be extracted in the current image can be determined by acquiring the pixel position of the pixel point in the reference image. Further, the image portion is extracted according to the pixel position of the pixel point that needs to be extracted in the current image, so as to achieve an anti-vibration purpose of the photography device.

In another embodiment, after the photography device executes an anti-vibration operation, an image adjustment can be performed on the obtained target captured image to eliminate the impact on the image during the anti-vibration operation. For example, the image adjustment can include smoothing the edges of the extracted image portion.

FIG. 11 is a structural schematic showing a photography device according to an example embodiment. As shown in FIG. 11, the photography device includes an image sensor 1101, and a processor 1102. The processor 1102 is configured to determine a vibration direction of the photography device when acquiring a current image relative to when acquiring a reference image. The processor 1102 is further configured to extract an image portion corresponding to the vibration direction in the current image according to the vibration direction, and determines the image portion corresponding to the vibration direction as a target captured image of the photography device.

In some embodiments, the processor 1102 can be configured to perform distortion correction on the current image to obtain a corrected captured image, and extract an image portion corresponding to the vibration direction from the corrected captured image.

In some embodiments, the size of the image portion corresponding to the vibration direction is consistent with the pixel size of the image sensor of the photography device.

In some embodiments, the processor 1102 can be configured to determine a vibration amplitude in the vibration direction, and extract an image portion corresponding to the vibration direction in the corrected captured image according to the vibration direction and the vibration amplitude.

In some embodiments, the processor 1102 can be configured to determine a pixel offset of the corrected captured image according to the vibration direction and the vibration amplitude, and extract an image portion corresponding to the vibration direction from the corrected captured image according to the pixel offset and the reference image.

In some embodiments, the vibration direction is a yaw direction and/or a pitch direction, and the vibration amplitude is a changing angle of the yaw angle and/or a changing angle of the pitch angle. Correspondingly, the processor 1102 can be configured to calculate the number of pixels corresponding to the vibration angle in the vibration direction according to the vibration direction and the vibration amplitude, and determine the number of pixels as the pixel offset of the corrected captured image.

In some embodiments, the vibration direction is a roll direction, and the vibration amplitude is a changing angle of a roll angle. Correspondingly, the processor 1102 can be configured to determine the vibration center in the vibration direction, determine the number of pixels corresponding to the vibration amplitude according to the vibration direction, the vibration center, and the vibration amplitude, and determine the number of pixels as the pixel offset of the corrected captured image.

In some embodiments, the vibration direction is a horizontal vibration direction or a vertical vibration direction, and the vibration amplitude is a vibration distance in the horizontal vibration direction or a vibration distance in the vertical vibration direction. Accordingly, the processor 1102 can be configured to determine an image distance and an object distance, calculate the number of pixels corresponding to the vibration distance in the vibration direction according to the vibration direction, the vibration amplitude, and image distance and the object distance, and determine the number of pixels as the pixel offset of the corrected captured image.

In some embodiments, the processor 1102 can be configured to obtain a pixel position of a pixel in a target captured image corresponding to the reference image in the reference image, where the target captured image corresponding to the reference image is an image generated after the reference image is subject to a distortion correction and an extraction. The processor 1102 can be also configured to calculate a second pixel position corresponding to a first pixel position according to the pixel offset, where the first pixel position is the pixel position in the target captured image corresponding to the reference image, and the second pixel position is the pixel position in the corrected captured image. The processor 1102 can be further configured to extract a pixel point at the second pixel position and obtain an image portion corresponding to the vibration direction.

In another embodiment, the processor 1102 can be further configured to perform an image adjustment on the target captured image.

The present disclosure also provides a computer-readable storage medium, where a computer program is stored. When the program is executed by the processor, the method according to above embodiment is implemented.

The present disclosure also provides a movable platform that includes the photography device according to above embodiments.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit. The integrated unit may be implemented in the form of hardware, or in the form of hardware plus software functional units.

A method consistent with the disclosure can be implemented in the form of computer program stored in a non-transitory computer-readable storage medium. The computer program can include instructions that enable a computer device, such as a personal computer, a server, or a network device, or a processor, to perform part or all of a method consistent with the disclosure, such as one of the example methods described above. The storage medium can be any medium that can store program codes, for example, a USB disk, a mobile hard disk, a read-only memory (ROM), a random access memory (RAM), a magnetic disk, or an optical disk.

For simplification purposes, detailed descriptions of the operations of example systems, devices, and units may be omitted and references can be made to the descriptions of the example methods.

The present disclosure has been described with the above embodiments, but the technical scope of the present disclosure is not limited to the scope described in the above embodiments. Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the claims.

What is claimed is:

1. An image processing method for a photography device comprising:
determining a vibration direction of the photography device when acquiring a current image relative to when acquiring a reference image; and
extracting, according to the vibration direction, an image portion corresponding to the vibration direction from the current image as a target captured image.

2. The method of claim 1, further comprising, before extracting the image portion:
performing distortion correction on the current image to obtain a corrected captured image;
wherein extracting the image portion includes extracting the image portion corresponding to the vibration direction from the corrected captured image.

3. The method of claim 2, wherein a size of the image portion is consistent with a pixel size of an image sensor of the photography device.

4. The method of claim 2, further comprising, before extracting the image portion from the corrected capture image:
determining a vibration amplitude in the vibration direction;
wherein extracting the image portion from the corrected capture image includes extracting the image portion from the corrected captured image according to the vibration direction and the vibration amplitude.

5. The method of claim 4, wherein extracting the image portion from the corrected captured image according to the vibration direction and the vibration amplitude includes:
determining a pixel offset of the corrected captured image according to the vibration direction and the vibration amplitude; and
extracting the image portion corresponding to the vibration direction from the corrected captured image according to the pixel offset and the reference image.

6. The method of claim 5, wherein:
the vibration direction includes at least one of a yaw direction or pitch direction; and
the vibration amplitude in the vibration direction includes at least one of a changing angle of a yaw angle or a changing angle of a pitch angle.

7. The method of claim 6, wherein determining the pixel offset of the corrected captured image according to the vibration direction and the vibration amplitude includes:
calculating a number of pixels corresponding to a vibration angle in the vibration direction according to the vibration direction, the vibration amplitude, and a Field of Vision (FOV) of the photography device; and
determining the number of pixels as the pixel offset of the corrected captured image.

8. The method of claim 5, wherein:
the vibration direction includes a roll direction; and
the vibration amplitude in the vibration direction includes a changing angle of the roll angle.

9. The method of claim 8, wherein determining the pixel offset of the corrected captured image according to the vibration direction and the vibration amplitude includes:
determining a vibration center in the vibration direction;
determining a number of pixels corresponding to the vibration amplitude according to the vibration direction, the vibration center, and the vibration amplitude; and
determining the number of pixels as the pixel offset of the corrected captured image.

10. The method of claim 5, wherein:
the vibration direction includes a horizontal or a vertical direction; and
the vibration amplitude in the vibration direction includes a vibration distance in the horizontal vibration direction or in the vertical vibration direction.

11. The method of claim 10, wherein determining the pixel offset of the corrected captured image according to the vibration direction and the vibration amplitude includes:
determining an image distance and an object distance;
calculating a number of pixels corresponding to the vibration distance in the vibration direction according to the vibration direction, the vibration amplitude, the image distance, and the object distance; and
determining the number of pixels as the pixel offset of the corrected captured image.

12. The method of claim 5, wherein extracting the image portion from the corrected captured image according to the pixel offset and the reference image includes:
obtaining first pixel positions of reference target pixels in the reference image, the reference target pixels being pixels in a reference target captured image generated by subjecting the reference image to a distortion correction and an extraction;
calculating, according to the pixel offset, second pixel positions in the corrected captured image that correspond to the first pixel positions; and
extracting pixel points at the second pixel positions to obtain the image portion corresponding to the vibration direction.

13. The method of claim 1, further comprising:
performing an image adjustment on the target captured image.

14. A photography device, comprising:
an image sensor; and
a processor configured to:
determine a vibration direction of the photography device when acquiring a current image relative to when acquiring a reference image; and
extract, according to the vibration direction, an image portion corresponding to the vibration direction from the current image as a target captured image.

15. The photography device of claim 14, wherein the processor is further configured to:
perform distortion correction on the current image to obtain a corrected captured image; and
extract the image portion corresponding to the vibration direction from the corrected captured image.

16. The photography device of claim 15, wherein a size of the image portion is consistent with a pixel size of the image sensor.

17. The photography device of claim 15, wherein the processor is further configured to:
determine a vibration amplitude in the vibration direction; and
extract the image portion corresponding to the vibration direction from the corrected captured image according to the vibration direction and the vibration amplitude.

18. The photography device of claim 17, wherein the processor is further configured to:
determine a pixel offset of the corrected captured image according to the vibration direction and the vibration amplitude; and
extract the image portion corresponding to the vibration direction from the corrected captured image according to the pixel offset and the reference image.

19. The photography device of claim 18, wherein:
the vibration direction includes at least one of a yaw direction or a pitch direction; and
the vibration amplitude includes at least one of a changing angle of a yaw angle or a changing angle of a pitch angle.

20. A movable platform comprising:
a photography device including:
an image sensor; and
a processor configured to:
determine a vibration direction of the photography device when acquiring a current image relative to when acquiring a reference image; and
extract, according to the vibration direction, an image portion corresponding to the vibration direction from the current image as a target captured image.
